(19) United States
(12) Patent Application Publication
(10) Pub. No.: US 2026/0349212 A1
(43) Pub. Date: Nov. 5, 2026

(54) OPTICAL DEVICE AND LENS MODULE THEREOF

(71) Applicant: Asia Optical Co., Inc., Taichung (TW)

(72) Inventors: De-Lun Liu, Taichung (TW); Po-Jen Wang, Taichung (TW)

(21) Appl. No.: 19/556,011

(22) Filed: Mar. 4, 2026

(30) Foreign Application Priority Data
Mar. 6, 2025 (TW) 114108332

(51) Int. Cl. G02B 7/02

(52) U.S. Cl. CPC G02B 7/021

(57) ABSTRACT

An optical device includes a lens module. The lens module includes a lens barrel, an objective lens, a propping-against element, a waterproof seal and an outer cover. The lens barrel includes an opening portion and a mounting portion. The objective lens includes a first radial flange. The waterproof seal is disposed in a seal-containing space formed by the opening portion of the lens barrel, the objective lens, and the propping-against element. A second radial flange of the outer cover is propped against the propping-against element thereby forcing the propping-against element against an annular inclined surface of the first radial flange and the mounting portion. The propping-against element is disposed between the waterproof seal and the outer cover.

### BACKGROUND OF THE INVENTION

### Field of the Invention

The invention relates to the technical field of a waterproof structure of an optical device, and more particularly to an optical device and the lens module thereof.

### Description of the Related Art

FIG. 1 depicts the structure of a conventional waterproof lens module, wherein the outermost lens LE of the lens module L is mounted in the mounting structure of the annular mounting part B1 of the lens barrel B. The side wall LW of the lens module L is propped against the inner surface of the lens barrel B. Moisture from the external environment may enter the interior of the lens module through the tiny gap formed between the lens L and the lens barrel B, to be condensed or even to grow mold on the optical surfaces of each lens element. That affects the image quality of each lens.

Conventionally, an O-ring R is placed between the outermost lens LE and the mounting portion B1 to solve the above problem. When the top cover C of the lens module L is screwed onto the lens barrel B, the top cover C forces the outermost lens LE against the O-ring R to generate a sealing effect wherein the O-ring R undergoes elastic deformation. However, the outermost lens LE and the adjacent lens L1 have a spacer ring R1 disposed therebetween that affects the amount of the deformation of the O-ring R. Specifically, the amount of deformation of the O-ring R is affected by the assembly tolerance between the outermost lens LE and the adjacent lens L1. Thus, when the assembly tolerance is too large, the gap between the outermost lens element LE and the mounting portion B1 be-comes too large, resulting in insufficient deformation (or even no deformation) of the O-ring R and failure of sealing. In addition, the lens barrel B and the top cover C are made of metal, while the outermost lens LE is made of glass. Therefore, the thermal expansion rates of the lens barrel B and the outermost lens LE are different. When the conventional waterproof lens module is affected by the ambient temperature, the gap between the outermost lens LE and the mounting portion B1 of the lens barrel B is increased.

### BRIEF SUMMARY OF THE INVENTION

The invention therefore provides an optical device and the lens module thereof to solve the described problem, wherein the waterproof structure of the invention is able to avoid from the affection by the assembly tolerance between lenses so as to maintain the sealing performance.

The lens module in accordance with an exemplary embodiment of the invention includes a lens barrel, an objective lens, a propping-against element, a waterproof seal and an outer cover. The lens barrel includes an opening portion and a mounting portion. The opening portion and the mounting are arranged along an optical axis of the lens module. The objective lens is disposed at the mounting portion, wherein the objective lens includes a lens body and a first radial flange, the first radial flange is extended radially from the lens body and away from the optical axis, and the first radial flange includes a first outer circumferential wall propped against the mounting portion, and an annular inclined surface adjoining the first outer circumferential wall. The waterproof seal is disposed in a seal-containing space formed by the opening portion of the lens barrel, the objective lens, and the propping-against element. The outer cover includes a connecting portion and a second radial flange, wherein the second radial flange is extended radially from the connecting portion and toward the optical axis, and the second radial flange is propped against the propping-against element thereby forcing the propping-against element against the annular inclined surface and the mounting portion. The propping-against element is disposed between the waterproof seal and the outer cover.

In another exemplary embodiment, the opening portion includes a first inner surface. The mounting portion includes a second inner surface. The first inner surface is flushed with the second inner surface.

In yet another exemplary embodiment, the opening portion includes a first inner surface. The mounting portion includes a second inner surface. The first inner surface and the second inner surface are arranged to form a stepped structure.

In another exemplary embodiment, the lens module satisfies 68%≤A2/A1≤125%, where A2 is a cross-sectional area of the waterproof seal and A1 is a cross-sectional area of the seal-containing space.

In yet another exemplary embodiment, the propping-against element and the second radial flange are formed into a continuous-unity annular rib.

In another exemplary embodiment, the outer cover, the propping-against element, the waterproof seal, and the annular inclined surface are arranged in order from an object side to an image side.

In yet another exemplary embodiment, the lens body includes a second outer circumferential wall adjoining the annular inclined surface. The propping-against element is disposed corresponding to the second outer circumferential wall.

In another exemplary embodiment, the lens body includes a first optical surface and a second optical surface disposed opposite to each other. The first optical surface is closer to an object side of the lens module than the second optical surface. The first radial flange is connected to the second optical surface.

In yet another exemplary embodiment, the lens module further includes a stopping inclined surface. The stopping inclined surface adjoins both the first optical surface and the second outer circumferential wall. The second radial flange is propped against the stopping inclined surface.

In another exemplary embodiment, a distance between the second radial flange and the annular inclined surface is less than a sum of a thickness of the waterproof seal and a thickness of the propping-against element when the second radial flange is propped against the stopping inclined surface.

In yet another exemplary embodiment, the connecting portion includes internal threads. The lens barrel includes external threads. The external threads and the internal threads are mated to connect the connecting portion and the lens barrel.

An optical device in accordance with an exemplary embodiment of the invention includes a lens module as described above. The lens module further includes at least one lens with positive refractive power and at least another lens with negative refractive power.

In the lens module of the invention, the waterproof seal is propped against the annular inclined surface of the objective lens that is oriented toward the opening portion. This avoids the assembly tolerance between lenses from affecting the installation of the waterproof seal and therefore avoids the conventional problem of poor sealing performance caused by insufficient deformation of the waterproof seal.

### BRIEF DESCRIPTION OF THE DRAWINGS

FIG. 1 is a sectional view of a conventional waterproof lens module.

FIG. 2 is a sectional view of a lens module in accordance with a first embodiment of the invention.

FIG. 3 is a local enlarged view of the lens module of FIG. 2.

FIG. 4 is a sectional view of a lens module in accordance with a second embodiment of the invention.

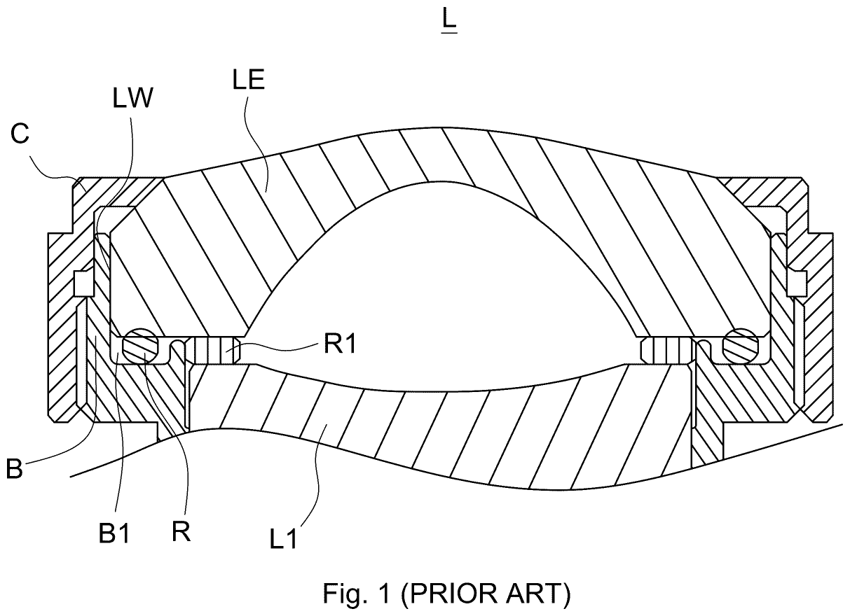

### DETAILED DESCRIPTION OF THE INVENTION

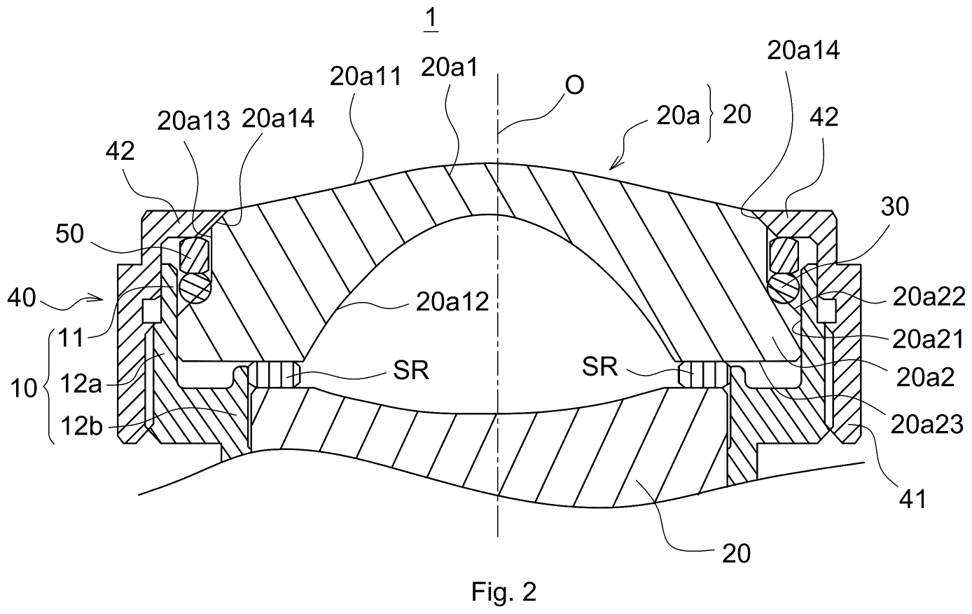

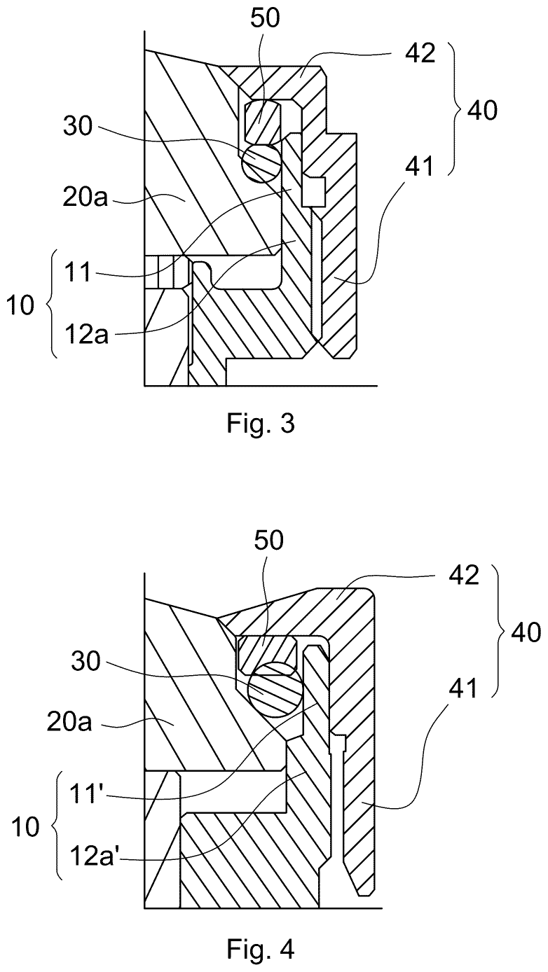

FIGS. 2 and 3 depict a lens module in accordance with a first embodiment of the invention. As shown, the lens module 1 includes a lens barrel 10, a waterproof seal 30, an outer cover 40, a propping-against element 50, and at least one spacer ring SR. The spacer ring SR is disposed between the lenses 20 to maintain the distance therebetween. The lens module 1 further includes a plurality of lenses 20, wherein at least one lens is with positive refractive power and at least another lens is with negative refractive power.

The lens module 1 has an optical axis O. The lens barrel is cylindrical in shape, and the optical axis O is coincident with the axis of the lens barrel 10. The lens barrel 10 includes an opening portion 11 and a plurality of mounting portions 12a and 12b. The opening portion 11 and the mounting portions 12a and 12b are also cylindrical in shape and arranged along the direction of the optical axis O. The plurality of lenses 20 are correspondingly disposed in the plurality of mounting portions 12a and 12b and arranged along the direction of the optical axis O.

The lens 20 includes an objective lens 20a which is disposed in the mounting portion 12a of the lens barrel 10. The objective lens 20a includes a lens body 20a1 and a first radial flange 20a2 extending radially from the lens body 20a1 and away from the optical axis O. The lens body 20a1 includes a first optical surface 20a11 and a second optical surface 20a12 disposed opposite to each other. The first optical surface 20a11 is closer to the object side of the lens module 1 than the second optical surface 20a12. Therefore, the first optical surface 20a11 is distant from other lenses 20, and the second optical surface 20a12 is close to other lenses 20. The first radial flange 20a2 is connected to the second optical surface 20a12. The first optical surface 20a11 and the second optical surface 20a12 individually include an optical effective area and a non-optical effective area. Light from the outside passes through the optical effective area to produce an optical effect (e.g., imaging). The non-optical effective area of the second optical surface 20a12 is propped against the spacer ring SR, and the spacer ring SR is propped against the lens 20 which is placed adjacent to the objective lens 20a, thereby forming an appropriate distance between the objective lens 20a and the adjacent lens 20 via the spacer ring SR. The first radial flange 20a2 includes a first outer circumferential wall 20a21 propped against the inner surface of the mounting portion 12a of the lens barrel 10, an annular inclined surface 20a22 facing the opening 11 and connected to the first outer circumferential wall 20a21, and a bottom wall 20a23 connected to the non-optical effective area of the second optical surface 20a12.

The waterproof seal 30 is disposed in a seal-containing space formed by the opening portion 11 of the lens barrel 10, the objective lens 20a, and the propping-against element 50. In this embodiment, the waterproof seal 30 is an O-ring.

The outer cover 40 includes a connecting portion 41 and a second radial flange 42 extending radially from the connecting portion 41 and toward the optical axis O. The connecting portion 41 is cylindrical in shape. In assembly of the lens module 1, the external threads of the lens barrel 10 and the internal threads of the connecting portion 41 are mated. Accordingly, the outer cover 40 is axially movable with respect to the lens barrel 10 so that the second radial flange 42 can approach or move away from the waterproof seal 30.

The propping-against element 50 is disposed between the waterproof seal 30 and the outer cover 40. The second radial flange 42 is propped against the propping-against element 50, with the connecting portion 41 moved along the optical axis O, thereby forcing the propping-against element 50 against the waterproof seal 30. The waterproof seal 30 undergoes appropriate elastic deformation and is propped against the inner surface of the annular inclined surface 20a22 and the mounting portion 12a of the lens barrel 10. In this way, the waterproof seal 30 can tightly contact the first outer peripheral wall 20a21 and the inner surface of the mounting portion 12a of the lens barrel 10 without gaps formed therebetween, whereby moisture from the external environment is prevented from entering the interior of the lens barrel 10.

The lens body 20a1 of the objective lens 20a includes a second outer circumferential wall 20a13 and a stopping inclined surface 20a14. The second outer circumferential wall 20a13 adjoins the annular inclined surface 20a22, and the propping-against element 50 is disposed corresponding to the second outer circumferential wall 20a13. Both the first optical surface 20a11 and the second outer circumferential wall 20a13 adjoin the stopping inclined surface 20a14, with the stopping inclined surface 20a14 disposed therebetween. In assembly, the outer cover 40 is connected to the lens barrel 10 in such a way that the outer cover 40 is moved with respect to the lens barrel 10 and along the optical axis O until the second radial flange 42 is propped against the stopping inclined surface 20a14. Therefore, the stopping inclined surface 20a14 is able to limit the axial movement stroke of the outer cover 40. The outer cover 40, the propping-against element 50, the waterproof seal 30, and the annular inclined surface 20a22 are arranged in order from an object side to an image side.

When the second radial flange 42 is propped against the stopping inclined surface 20a14, the distance between the second radial flange 42 and the annular inclined surface 20a22 is less than the sum of the thicknesses of the waterproof seal 30 and the thickness of the propping-against element 50.

As described above, the waterproof seal 30 placed in the lens module 1 undergoes elastic deformation. In this embodiment, the degree of deformation of the waterproof seal 30 placed in the lens module 1 can be adjusted by using different propping-against elements 50 of different thicknesses. However, the invention is not limited thereto. In some other embodiments, the propping-against element and the second radial flange of the outer cover can be formed into a continuous-unity structure, namely the propping-against element is an annular rib provided on the second radial flange. Similarly, the degree of deformation of the waterproof seal 30 can be adjusted by using different annular ribs of different thicknesses.

As described above, the opening portion 11, the objective lens 20a and the propping-against portion 50 have a seal-containing space formed therebetween to contain the waterproof seal 30. A fill ratio R can be defined as the ratio of the cross-sectional area A2 of the waterproof seal 30 to the cross-sectional area A1 of the seal-containing space. If the fill ratio R is too small, it means that the cross-sectional area A2 of the waterproof seal 30 is too small, which will result in poor sealing performance. However, if the fill ratio R is too large, it means that the cross-sectional area A2 of the waterproof seal 30 is too large, and the waterproof seal 30 is subjected to excessive pressure after assembly, which may cause permanent deformation of the waterproof seal 30 or even some other problems such as the top cover not being able to be locked in place. In the invention, therefore, the fill rate R is designed to satisfy the condition: 68%≤A2/A1≤125% where A2 is the cross-sectional area of the waterproof seal 30 and A1 is the cross-sectional area of the seal-containing space.

FIG. 4 depicts a second embodiment of the invention, wherein the elements same as those of the first embodiment are indicated with the same reference numerals and the descriptions thereof are omitted. The second embodiment differs from the first embodiment in that the inner surface of the opening portion 11 is flushed with the inner surface of the mounting portion 12a in the first embodiment (FIG. 3), while the inner surface of the opening portion 11′ and the inner surface of the mounting portion 12a′ are arranged to be a stepped structure in the second embodiment (FIG. 4). This difference allows the second embodiment to provide a larger seal-containing space than the first embodiment under the same external shape of the lens barrel 10. In other words, the fill rate R of the second embodiment is smaller than that of the first embodiment under the same external shape of the lens barrel 10.

The lens module 1 of the invention can be used in different optical devices, such as sport photography lenses or vehicle lenses.

In the lens module of the invention, the waterproof seal is propped against the annular inclined surface of the objective lens that is oriented toward the opening portion. This avoids the assembly tolerance between lenses from affecting the installation of the waterproof seal and therefore avoids the conventional problem of poor sealing performance caused by insufficient deformation of the waterproof seal. Further, when the distance between the objective lens and the lens barrel is affected by the ambient temperature to in-crease, the compression of the waterproof seal can be adjusted in accordance with the change in the distance between the objective lens and the lens barrel because the waterproof seal is propped against the annular inclined surface of the objective lens. In the invention, therefore, the sealing effect can be maintained.

What is described above is only the preferred embodiment of the invention, and the scope of the invention is not limited thereto. That is, the simple equivalent changes and modifications made according to the description of the invention and the claims are all within the scope of the invention. Further, any one of the embodiments or claims is not required to achieve all the objects or advantages or features of the invention. Further, the abstract and title are only used to assist in the search of patent documents and are not intended to limit the scope of the invention.

What is claimed is:

1. A lens module, comprising:
a lens barrel comprising an opening portion and a mounting portion, wherein the opening portion and the mounting are arranged along an optical axis of the lens module;
an objective lens disposed at the mounting portion, wherein the objective lens comprises a lens body and a first radial flange, the first radial flange is extended radially from the lens body and away from the optical axis, and the first radial flange comprises a first outer circumferential wall propped against the mounting portion, and an annular inclined surface adjoining the first outer circumferential wall;
a propping-against element;
a waterproof seal disposed in a seal-containing space formed by the opening portion of the lens barrel, the objective lens, and the propping-against element;
an outer cover comprising a connecting portion and a second radial flange, wherein the second radial flange is extended radially from the connecting portion and toward the optical axis, and the second radial flange is propped against the propping-against element thereby forcing the propping-against element against the annular inclined surface and the mounting portion;
wherein the propping-against element is disposed between the waterproof seal and the outer cover.

2. The lens module as claimed in claim 1, wherein:
the opening portion comprises a first inner surface;
the mounting portion comprises a second inner surface;
the first inner surface is flushed with the second inner surface.

3. The lens module as claimed in claim 1, wherein:
the opening portion comprises a first inner surface;
the mounting portion comprises a second inner surface;
the first inner surface and the second inner surface are arranged to form a stepped structure.

4. The lens module as claimed in claim 1, wherein the lens module satisfies: 68%≤A2/A1≤125%,
where A2 is a cross-sectional area of the waterproof seal and A1 is a cross-sectional area of the seal-containing space.

5. The lens module as claimed in claim 1, wherein the propping-against element and the second radial flange are formed into a continuous-unity annular rib.

6. The lens module as claimed in claim 1, wherein the outer cover, the propping-against element, the waterproof seal, and the annular inclined surface are arranged in order from an object side to an image side.

7. The lens module as claimed in claim 1, wherein:
the lens body comprises a second outer circumferential wall adjoining the annular inclined surface;
the propping-against element is disposed corresponding to the second outer circumferential wall.

8. The lens module as claimed in claim 7, wherein:
the lens body comprises a first optical surface and a second optical surface disposed opposite to each other;
the first optical surface is closer to an object side of the lens module than the second optical surface;
the first radial flange is connected to the second optical surface.

9. The lens module as claimed in claim 8, further comprising:
a stopping inclined surface;
wherein the stopping inclined surface adjoins both the first optical surface and the second outer circumferential wall;
the second radial flange is propped against the stopping inclined surface.

10. The lens module as claimed in claim 9, wherein a distance between the second radial flange and the annular inclined surface is less than a sum of a thickness of the waterproof seal and a thickness of the propping-against element when the second radial flange is propped against the stopping inclined surface.

11. The lens module as claimed in claim 9, wherein:
the connecting portion comprises internal threads;
the lens barrel comprises external threads;
the external threads and the internal threads are mated to connect the connecting portion and the lens barrel.

12. An optical device, comprising:
the lens module as claimed in claim 1;
wherein the lens module further comprises at least one lens with positive refractive power and at least another lens with negative refractive power.
